(19) United States
(12) Patent Application Publication
(10) Pub. No.: US 2005/0199629 A1
(43) Pub. Date: Sep. 15, 2005

(54) Lock for a storage container of a respirator

(75) Inventor: Joachim Schlobohm, Bad Oldesloe (DE)

Correspondence Address: MCGLEW & TUTTLE, PC, P.O. BOX 9227, SCARBOROUGH STATION, SCARBOROUGH, NY, 10510-9227, US

(73) Assignee: Drager Safety AG & Co., Lubeck (DE)

(21) Appl. No.: 10/999,701

(22) Filed: Nov. 30, 2004

(30) Foreign Application Priority Data
Mar. 13, 2004 (DE) 10 2004 012 450.7

(51) Int. Cl. B65D 45/32; A62B 18/08; A62B 19/00

(52) U.S. Cl. 220/319; 128/206.17

(57) ABSTRACT

A lock for a storage container of a respirator has a simple design, can be removed in a short time and offers good gas tightness. A cover band (2) holds two container parts (4, 5) together. The cover band is formed of an elastomer material. On an inner side of the cover band, in the area of a connection point (9), a peripheral sealing lip (15) acting as a seal, bridges over the connection point (9). The sealing lip is accommodated in a groove (12) between the projections (10, 11).

### CROSS REFERENCE TO RELATED APPLICATIONS

This application claims the benefit of priority under 35 U.S.C. § 119 of DE 10 2004 012 450.7 filed Mar. 13, 2004, the entire contents of which are incorporated herein by reference.

### FIELD OF THE INVENTION

The invention relates generally to a lock for a storage container of a respirator and more particularly to a lock in combination with two container parts, which have a seal along a connection point and projections extending around the edges, which are held together by a cover band.

### BACKGROUND OF THE INVENTION

A lock for a storage container of a respirator has become known from the utility model DE 1 734 071 U. Such storage containers normally comprise two container parts, whose connection point is covered with a sealing ring. For protection against mechanical damage, the sealing ring is surrounded by a metal band extending along the connection point. It is also known that the edge parts of the cover band are bent off inwardly so that they extend around corresponding projections in a clamp-like manner in order to firmly connect the container parts with one another. One end of the cover band is provided with a tear tab, with which the cover band can be removed from the storage container. In addition to the cover band, a tear wire is provided, which extends along the seal. The tear wire is carried during the separation of the cover strip and severs the sealing ring.

The prior-art lock has a relatively complicated design, because a cover band, a sealing ring and a tear wire are needed. Too much time is needed to open the storage container and remove the respirator when a real need to use the container occurs.

### SUMMARY OF THE INVENTION

The basic object of the present invention is to provide a lock for a respirator, which lock has a simple design, can be removed in a short time and has good gas tightness.

According to the invention a lock for a storage container of a respirator is provided or a lock and container assembly is provided. The container has two container parts which have a seal along a connection point. The projections extend around the edges, which are held together by a cover band. The cover band comprises or consists essentially of an elastomer material (has elastomer properties). The cover band has on its inner side in the area of the connection point, a peripheral sealing lip acting as a seal, which bridges over the connection point and is accommodated in a groove between the projections.

The advantage of the present invention relates particularly to the elastomeric cover band extending around the projections extending around the parts of the container in the area of the connection point. As a result, the cover band fixes the parts of the container against each other, on the one hand, and seals the connection point (i.e., the connection interface) toward the environment due to the elasticity of the cover band, on the other hand. In addition, the connection point is closed by a sealing lip, which lies within the groove between the projections and is located in the middle of the cover band. Due to the double sealing function, partly in the connection area between the cover band and the projections and by the sealing lip at the connection point between the parts of the container, the storage container is insensitive to variations in temperature and pressure. In addition, the cover band can be removed from the storage container in a nondestructive manner and then reattached for the purposes of testing the respirator.

Thermoplastic elastomers are especially well suited for use as materials for the cover band.

Recesses, which have a design corresponding to the projections and extend around the projections, are advantageously present at the cover band. The sealing function can be further improved by a profile at the projections, which presses into the elastomer material of the cover band.

An exemplary embodiment of the present invention is shown in the figure and will be explained in greater detail below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a front view of a storage container for a respirator according to the invention;

FIG. 2 is a sectional view along line B-B of the storage container according to FIG. 1;

FIG. 3 is a sectional view along line A-A according to FIG. 1;

FIG. 4 is a top broken away perspective view of the storage container in the area of the opening lever;

FIG. 5 is a perspective view of a lead seal in the area of the opening lever; and

FIG. 6 is a top broken away perspective view of the storage container with the lead seal removed.

### DESCRIPTION OF THE PREFERRED EMBODIMENT

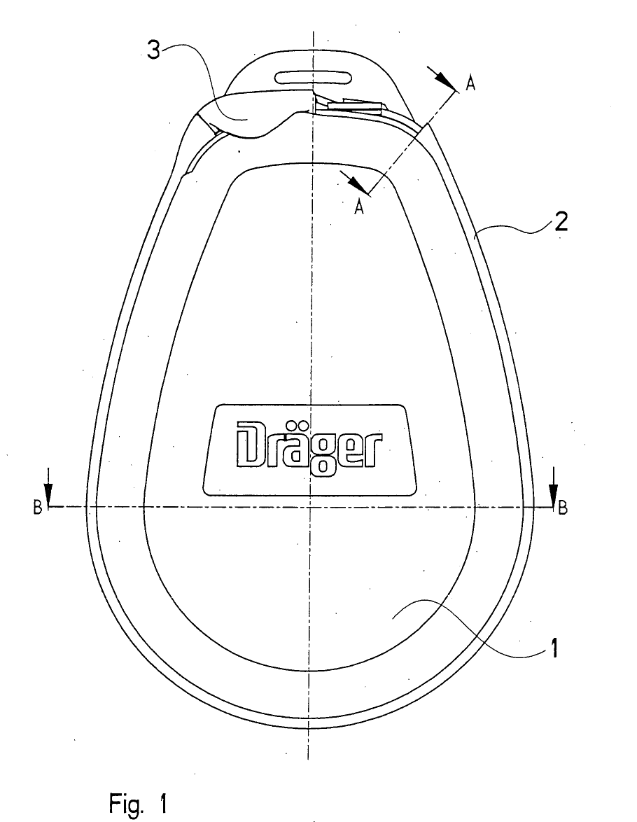

FIG. 1 shows a storage container 1, which is closed with a peripheral cover band 2, wherein an opening lever 3 for removing the cover band 2 is provided on the top side of the storage container 1.

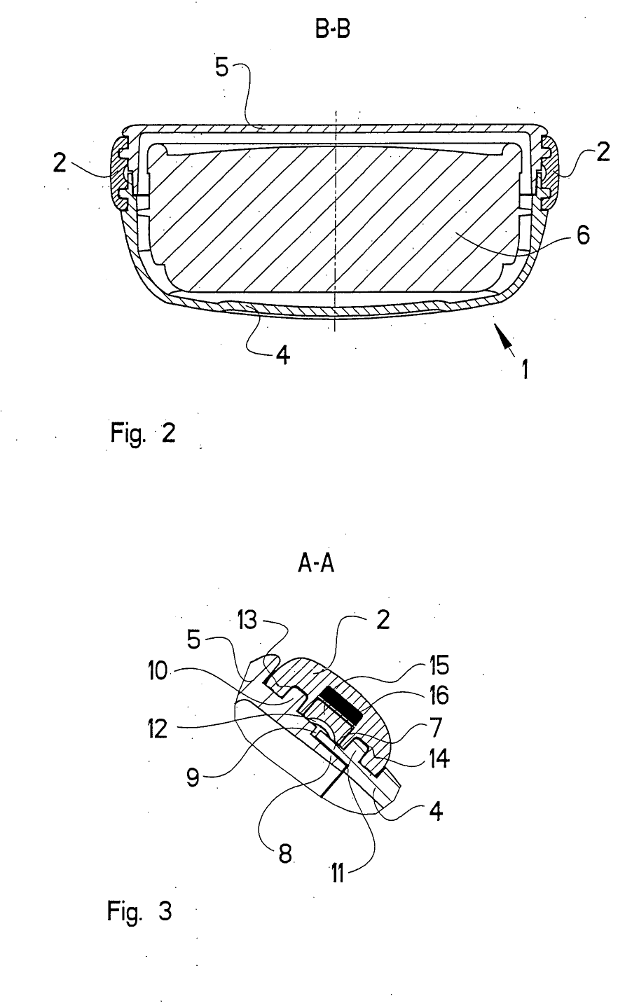

FIG. 2 illustrates the storage container 1 in the sectional view B-B according to FIG. 1. The storage container 1 comprises a first container part 4 and a second container part 5, between which the respirator 6 is accommodated.

FIG. 3 shows the sectional view A-A according to FIG. 1. On the front sides, the container parts 4, 5 have guide surfaces 7, 8, which mesh with one another and fix the container parts 4, 5 against each other at the connection point 9. Peripheral projections 10, 11 are arranged at the container parts 4, 5 symmetrically to the connection point 9. A groove 12 with the connection point 9 is located between the projections 10, 11.

The cover band 2, which consists of a thermoplastic elastomer, has recesses 13, 14, which are designed corresponding to the projections 10, 11, and a sealing lip 15, which covers the connection point 9, within the groove 12. An end piece 16 of the opening lever 3 consisting of a solid material, FIG. 1, is connected with the cover band 2.

The gas tightness between the environment and the interior space of the storage container 1 arises from the interplay between the projections 10, 11, on the one hand, and the recesses 13, 14, on the other hand, and the separate sealing of the connection point 9 with the sealing lip 15. An additional sealing function is achieved by the meshing of the guide surfaces 7, 8. To test the respirator 6, the cover band 2 can be removed from the storage container 1, FIG. 1, in a nondestructive manner and then reused.

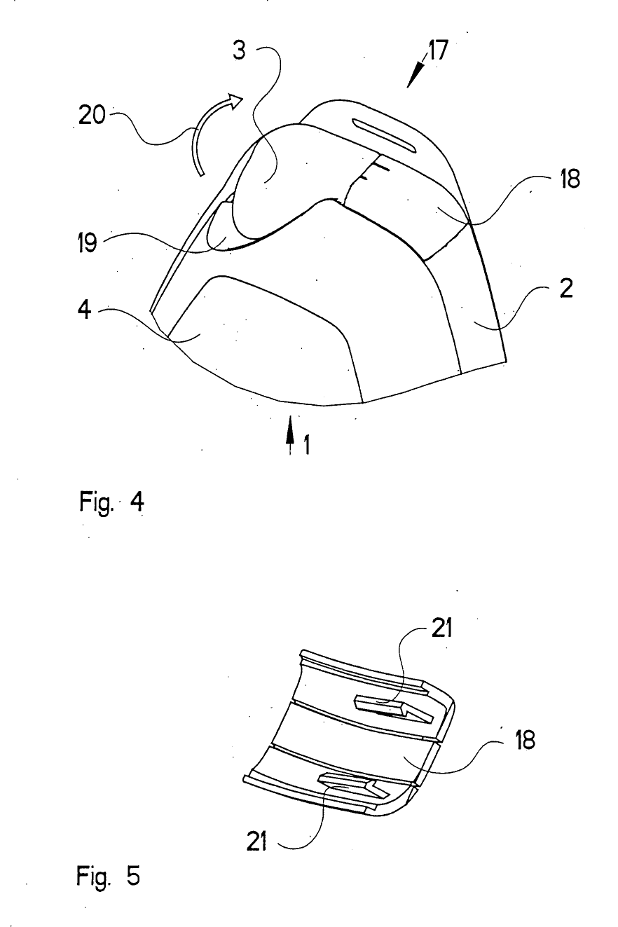

FIG. 4 illustrates the storage container 1 in a cutout, perspective view with a view toward the opening lever 3. The opening lever 3 is part of a lock 17 for the cover band 2, which contains a lead seal 18. To open the lock 17, the user grasps under the opening lever 3 via a recessed grip 19 in the direction of arrow 20. The lead seal 18 is forced open in the upward direction and the cover band 2 becomes detached from the storage container 1.

FIG. 5 shows the lead seal 18 from below with individual catch springs 21.

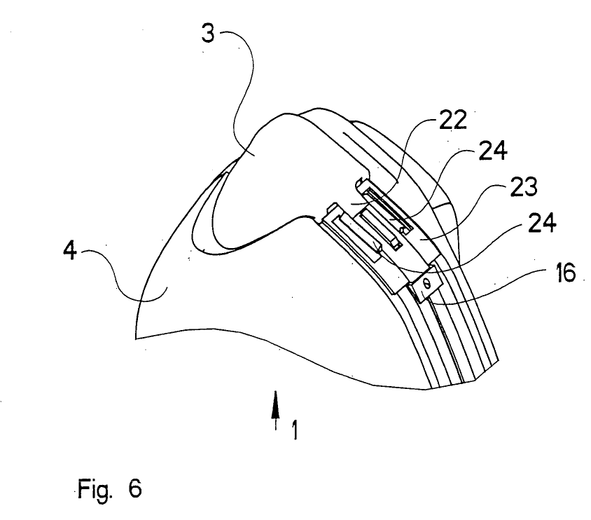

FIG. 6 illustrates the storage container 1 with the lead seal 18 removed in the same perspective view as does FIG. 4. The cover band 2, which is attached to the end piece 16, is likewise not shown for the sake of greater clarity. A lever section 22 of the opening lever 3 lies above a holding plate 23, which has counterparts designed corresponding to the catch springs 21. The lead seal 18, FIG. 5, is placed on the holding plate 23 from the top, and the catch springs 21 snap into the counterparts 24. When the opening lever 3 is actuated, the lead seal 18 is forced open by the lever section 22 off from the holding plate 23. The holding plate 23 forms the lock 17 together with the lead seal 18 and the lever section 22 of the opening lever 3.

While a specific embodiment of the invention has been shown and described in detail to illustrate the application of the principles of the invention, it will be understood that the invention may be embodied otherwise without departing from such principles.

1. A lock for a storage container of a respirator with two container parts which have a seal along a connection point, the lock comprising:
projections, each of said projections extending around an edge of each container part;
a cover band for holding the container parts together, said cover band being formed of an elastomer material and having an inner side in the area of the connection point with a peripheral sealing lip acting as a seal, said sealing lip bridging over the connection point and being accommodated in a groove between said projections.

2. A lock in accordance with claim 1, wherein said cover band has recesses with a shape corresponding to said projections, said recesses each extending respectively around one of said projections.

3. A lock in accordance with claim 1, wherein said cover band consists of a thermoplastic elastomer.

4. A respirator container, comprising:
a first container part having a first sealing edge;
a second container part having a second sealing edge, said first sealing edge and said second sealing edge defining a connection region;
a lock including a first projection extending at least partially around said first container part adjacent to said first sealing edge, a second projection extending at least partially around said second container part adjacent to said second sealing edge and a cover band for holding the container parts together, said cover band having elastomeric properties and having an inner side with a peripheral sealing lip acting as a seal, said sealing lip bridging over the connection region and being accommodated in a groove between said first projection and said second projection.

5. A respirator container in accordance with claim 4, wherein said cover band has a first recess with a shape corresponding to said first projection and extending around said first projection and a second recess with a shape corresponding to said second projection and extending around said second projection.

6. A respirator container in accordance with claim 4, wherein said cover band consists of a thermoplastic elastomer.

7. A respirator container assembly, comprising:
a respirator;
a first container part having a first sealing edge;
a second container part having a second sealing edge, said first sealing edge and said second sealing edge defining a connection region and defining a respirator receiving space, said respirator being accommodated in said respirator receiving space;
a lock including a first projection extending at least partially around said first container part adjacent to said first sealing edge, a second projection extending at least partially around said second container part adjacent to said second sealing edge and an elastic cover band for holding the container parts together, said cover band having an inner side with a peripheral sealing lip acting as a seal, said sealing lip bridging over the connection region and being accommodated in a groove between said first projection and said second projection.

8. A respirator container assembly in accordance with claim 7, wherein said cover band has a first recess with a shape corresponding to said first projection and extending around said first projection and a second recess with a shape corresponding to said second projection and extending around said second projection.

9. A respirator container assembly in accordance with claim 7, wherein said cover band consists of a thermoplastic elastomer.
